(19) United States
(12) Patent Application Publication
(10) Pub. No.: US 2011/0011910 A1
(43) Pub. Date: Jan. 20, 2011

(54) MONITOR SUPPORTING STRUCTURE

(76) Inventor: Ailang Hsiao, Taipei (TW)

Correspondence Address: KILE PARK GOEKJIAN REED & MCMANUS, 1200 NEW HAMPSHIRE AVE, NW, SUITE 570, WASHINGTON, DC, 20036, US

(21) Appl. No.: 12/830,449

(22) Filed: Jul. 6, 2010

(30) Foreign Application Priority Data
Jul. 15, 2009 (TW) 98212896

(51) Int. Cl. B60R 11/00

(52) U.S. Cl. 224/555

(57) ABSTRACT

The invention relates to a monitor supporting structure disposed on a rear side of a car monitor. The monitor supporting structure includes two first connecting members, two second connecting members and two universal joints. The two first connecting members are connected on the rear side of the car monitor. Each second connecting member has a sleeve on one side thereof, and the sleeve has a through-hole portion thereinside. The universal joint is disposed between one of the first connecting members and the corresponding second connecting member. The through-hole portion of the sleeve can be assembled on the head-restraint metal-rods; further, due to the rotation of the two second connecting members, the monitor supporting structure can be applied in different cars. Moreover, the angle and the position of the monitor can be easily adjusted.

### BACKGROUND OF THE INVENTION

1. Field of the Invention

The present invention is a monitor supporting structure; especially, the present invention relates to a monitor supporting structure for assembling monitor in the car.

2. Description of Related Art

With the improvement of the car application, more cars has monitor assembled thereinside so that passengers can watch TV program during transportation. Traditionally, the car seat is formed to have a receiving slot on the rear surface thereof for inserting the monitor into the receiving slot. The traditional assembling method is complex and the original structure has to be disassembled and re-assembled to fix the monitor. Therefore, the structure of the car seat is broken and the strength may decrease. In other words, the traditional assembling method may result in car safety issue. Furthermore, the traditional assembling method costs much money. On the other hand, the angle and horizontal position of the assembled monitor due to the monitor is inserted inside the receiving slot; therefore, the traditional assembled monitor is not friendly for the uses.

A traditional device has a bottom seat with a plate, a decorating seat disposed on the plate, an adjusting member, and a monitor fixed on the adjusting member. The decorating seat has a wall defining a recess, a substrate connected with the lower edge of the wall, and a window inside the wall. The substrate and the window are respectively close to a lower portion and an upper portion. The adjusting member is received in the recess of the decorating seat. The adjusting member has a first positioning portion, which is corresponding to the window, on the upper portion. The adjusting member further has a second positioning portion, which is located above the substrate of the decorating seat, on the lower portion. The first positioning portion is pivoted on the bottom seat so that the second positioning portion can be moved relative to the substrate. The structure of the traditional device is complex and it is difficult to assemble the device in the car. Further, user can only adjust the angle upward or downward; therefore, it is not convenient for users to watching the display on the device.

Another traditional head-restraint monitor is assembled on the rear side of the car seat and the monitor may result in the decreasing of the strength of head-restraint and the metal rod. The decreased strength may not meet the requirement of passing the impact test.

On the other hand, some traditional car monitor can be assembled on the head-restraint metal-rod of the car seat. However, they are not suitable for different cars because of the different distance between two head-restraint metal-rods, and different size and shape of the car seat.

Consequently, with regard to the resolution of defects illustrated hereinbefore, the inventors of the present invention propose a reasonably designed solution for effectively eliminating such defects.

### SUMMARY OF THE INVENTION

The objective of the present invention is to provide a monitor supporting structure. It is convenient for adjusting the monitor when the monitor is assembled on the monitor supporting structure of the present invention so that users can clearly watch the display on the monitor.

Another objective of the present invention is to provide a monitor supporting structure characterized in easy assembling and simple structure. The monitor supporting structure can be assembled on different cars so as to reduce assembling cost.

To achieve the objective described as above, the present invention discloses a monitor supporting structure disposed on a rear side of a monitor in a car. The monitor supporting structure includes: two first connecting members, connected on the rear side of the monitor; two second connecting members, connected on a car seat, each second connecting member having a sleeve on one side thereof, and the sleeve having a through-hole portion; and two universal joints, one of the universal joints being disposed between one of the first connecting members and the corresponding second connecting member.

The present invention provides the following beneficial effects: the universal joint is connected between the first connecting member and the second connecting member so that users can adjust the angle of the monitor by rotating the monitor 1 via the universal joint. The sleeve of the second connecting member can be used to connect with the head-restraint metal-rod of different cars so that the monitor can be fixed in different cars. Accordingly, it is more convenient for assembling the monitor on the car seat and for adjusting the monitor to watch the program showing on the monitor. Furthermore, the monitor supporting structure of the present invention is used for assembling monitor without dissembling and re-assembling the original car seat so that the cost for assembling monitor on the car seat 2 is reduced and the structure strength of car seat is maintained.

The monitor supporting structure of the present invention further is provided for adjusting the horizontal position of assembled monitor.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is a explored diagram of the monitor supporting structure according to the present invention;

FIG. 2 is a structural diagram of the monitor supporting structure according to the present invention;

FIG. 3 is a structural diagram of the monitor supporting structure assembled in the car according to the present invention;

FIG. 4 is a structural diagram showing that the monitor supporting structure is adjusted according to the present invention; and

FIG. 5 is another structural diagram showing that the monitor supporting structure is adjusted according to the present invention.

### DETAILED DESCRIPTION OF THE PREFERRED EMBODIMENTS

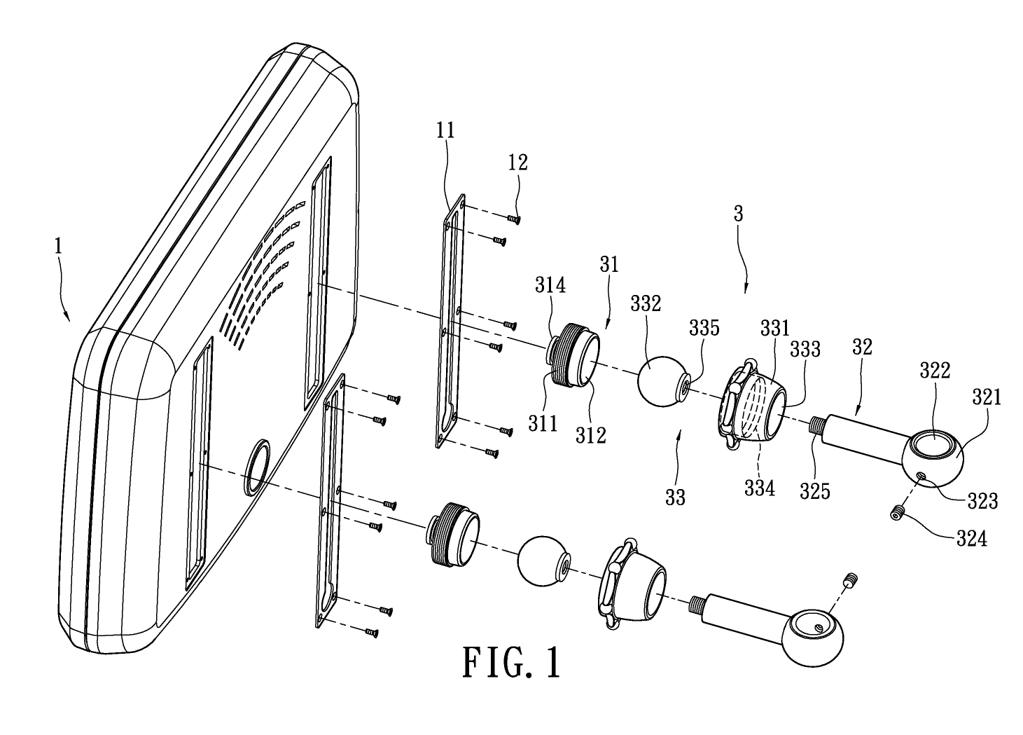

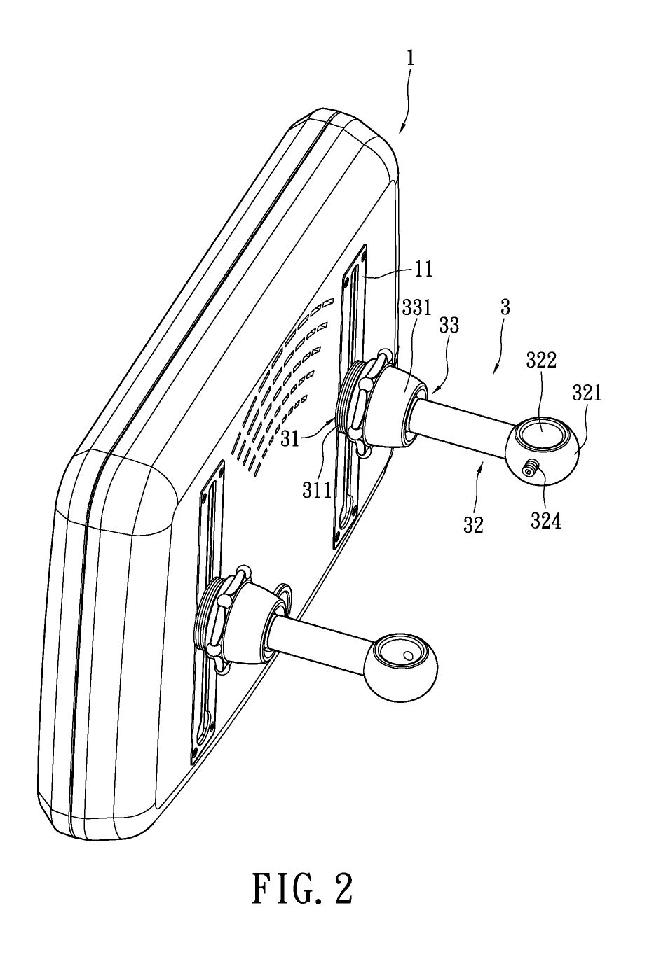

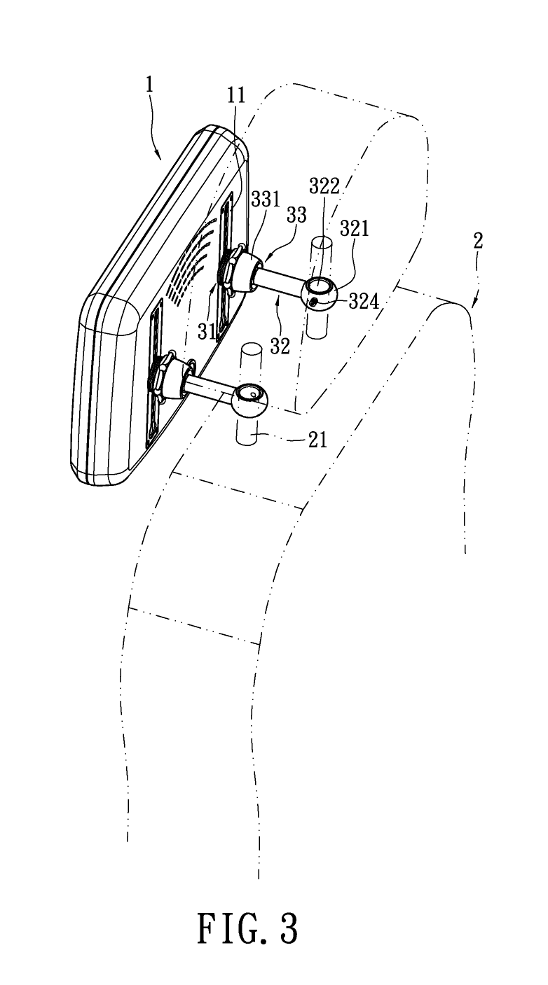

Refer now to FIG. 1 to FIG. 3, wherein the present invention provides a monitor supporting structure 3 which is disposed on a rear side of a monitor 1 and the monitor supporting structure 3 is used for fixing the monitor 1 on the head-restraint metal-rod 21 of a car seat 2. In the embodiment, the car seat 2 has two head-restraint metal-rods 21, and each head-restraint metal-rod 21 is a circular rod. The monitor supporting structure 3 has two first connecting members 31, two second connecting members 32 and two universal joints 33. The first connecting member 31 is a circular seat and has first thread portion 311 on an outer wall thereof. The first connecting member 31 has a concave portion 312 thereinside, and the concave portion 312 is a circular slot corresponding to the shape of a ball body 332 of the universal joint 33. The two first connecting members 31 is slidably fixing on and located on the same horizontal level on the rear side of the monitor 1 so that the monitor supporting structure 3 is disposed on the rear side of the monitor 1.

The two second connecting members 32 are long rods and each second connecting members 32 has a sleeve 321, for example a turning knob, on one side thereof. The sleeve 321 has a circular through-hole portion 322 thereinside, and the through-hole portion 322 extends from the top of the sleeve 321 to the bottom of the sleeve 321. The internal diameter of the through-hole portion 322 is larger than the external diameter of head-restraint metal-rod 21 so that the head-restraint metal-rods 21 of the car seat 2 can insert through the through-hole portion 322. In other words, the through-hole portion 322 of the sleeve 321 of the second connecting member 32 can be located at any position on the head-restraint metal-rods 21 of the car seat 2; therefore, the monitor supporting structure 3 can be connected with the head-restraint metal-rods 21 of the car seat 2. The sleeve 321 of the second connecting member 32 has a threaded hole 323 on a side wall thereof and the threaded hole 323 is horizontally extending. The threaded hole 323 communicates with the through-hole portion 322. Moreover, a fixing screw 324 is screwed with the threaded hole 323. The fixing screw 324 extends from the threaded hole 323 into the through-hole portion 322 of the sleeve 321, and the fixing screw 324 selectively abuts against the head-restraint metal-rods 21 of the car seat 2 for securing the head-restraint metal-rods 21 and the second connecting member 32.

One universal joint 33 is connected between one first connecting member 31 and the corresponding second connecting member 32. The universal joint 33 has a ball seat 331 and a ball body 332. The ball seat 331 is a circular seat and has a circular hole portion 333 thereinside. The circular hole portion 333 is corresponding the shape of the ball body 332. The circular hole portion 333 has two openings on two sides thereof, and the ball seat 331 has second thread portion 334 on an inner wall thereof. The ball body 332 has a connecting hole 335 on one side thereof, and the second connecting member 32 has a connecting bolt 325, which is corresponding to the connecting hole 335, on the other side thereof. The connecting bolt 325 of the second connecting member 32 is screwed with the connecting hole 335 of the ball body 332 so that the two ball bodies 332 are respectively connected with the other side of the corresponding second connecting member 32. The ball body 332 is rotatably received in the circular hole portion 333 of the ball seat 331. The second thread portion 334 of the ball seat 331 is screwed and engaged with the first thread portion 311 of the first connecting member 31 so that the two ball seats 331 are respectively connected to the two first connecting members 31, and the ball body 332 is positioned in the circular hole portion 333 of the ball seat 331. The ball body 332 is partially received in the concave portion 312 of the first connecting member 31 so that the universal joint 33 is connected between one first connecting member 31 and the corresponding second connecting member 32. Accordingly, the above-mentioned members are constructed into the monitor supporting structure 3 of the present invention.

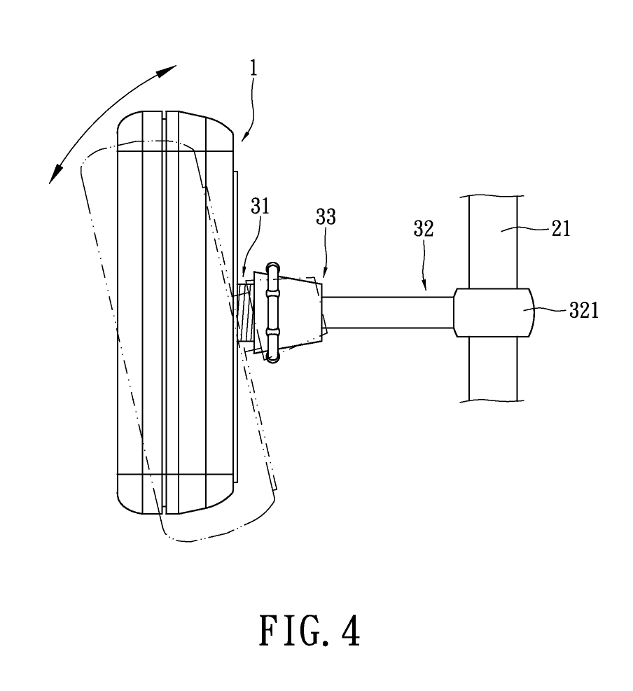

Two second connecting members 32 are provided and assembled with the head-restraint metal-rods 21 of the car seat 2 for supporting and fixing the monitor 1 on the head-restraint metal-rods 21 of the car seat 2. Because of the universal joint 33 connected between the first connecting member 31 of the monitor supporting structure 3 and the second connecting member 32. Users can adjust the angle of the monitor 1 by rotating the monitor 1 via the universal joint 33 (as shown in FIG. 4).

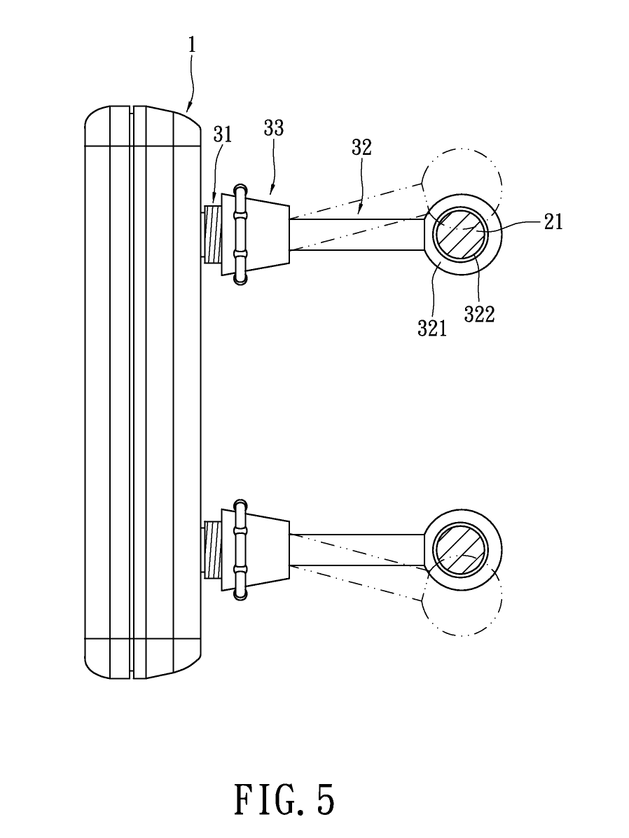

The two second connecting members 32 of the monitor supporting structure 3 are movably assembled on the head-restraint metal-rods 21 of the car seat 2 via the sleeves 321 so that the two second connecting members 32 can move rightward or leftward, as shown in FIG. 5, to meet the length requirement of different car seat 2. When the positions are confirmed, the fixing screw 324 is screwed to abut against the head-restraint metal-rods 21 of the car seat 2; therefore, the two second connecting members 32 are fixed on the head-restraint metal-rods 21 of the car seat 2.

In the embodiment, the monitor 1 further has two tracks 11 on the rear side thereof and the tracks 11 are fixed on the rear side of the monitor 1 by screws 12. The two tracks 11 extend vertically and are parallel with each other. The first connecting member 31 has a slidable portion 314 on one side thereof, and the slidable portion 314 is slidably engaged with the track 11. The slidable portion 314 is temporarily fixed with the track 11 and user can force to slide the slidable portion 314 on the track 11. In an unforced case, the slidable portion 314 is temporarily fixed with the track 11 again to fix the monitor 1. Therefore, the horizontal position of the monitor 1 can be adjusted.

On the other hand, the pressure of the turning-knob sleeve 321 can be provided for adjusting the angle and the horizontal position of the monitor 1. Moreover, when the impact force is larger than the pressure, the monitor 1 can simultaneously slides downward to prevent from falling down and injuring the passengers.

Certainly, the monitor supporting structure 3 of the present invention is used for assembling monitor 1 without dissembling and reassembling the original car seat 2. Therefore, the cost for assembling monitor 1 on the car seat 2 is reduced and the original car seat 2 is kept to maintain the car safety. Furthermore, it is more convenient for adjusting the monitor and watching the program showing on the monitor.

In addition, the monitor supporting structure 3 is constructed by the first connecting member 31, the second connecting member 32 and the universal joint 33; therefore, the monitor supporting structure 3 has module structure and is easily assembled. Moreover, the monitor supporting structure 3 can be used in different cars and the assembling cost is lower.

The texts set forth hereinbefore illustrate simply the preferred embodiments of the present invention, rather than intending to restrict the scope of the present invention claimed to be legally protected thereto. All effectively equivalent changes made by using the contents of the present disclosure and appended drawings thereof are included within the scope of the present invention delineated by the following claims.

What is claimed is:

1. A monitor supporting structure used in a car, and disposed on a rear side of a monitor, comprising:
two first connecting members, connected on the rear side of the monitor;
two second connecting members, connected on a car seat, each second connecting member having a sleeve on one side thereof, and the sleeve having a through-hole portion thereinside; and
two universal joints, one of the universal joints being disposed between one of the first connecting members and the corresponding second connecting member.

2. The monitor supporting structure according to claim 1, wherein the rear side of the monitor further has two tracks extending vertically, each first connecting member has a slidable portion and the slidable portion is slidably engaged with the track.

3. The monitor supporting structure according to claim 1, wherein the two first connecting members are located on the same horizontal level on the rear side of the monitor.

4. The monitor supporting structure according to claim 1, wherein each the two universal joints has a ball seat and a ball body, the ball seat has a circular hole portion thereinside, the circular hole portion has two openings on two sides thereof, the ball body is connected with the other side of the second connecting member, and the ball body is rotatably received in the circular hole portion of the ball seat.

5. The monitor supporting structure according to claim 4, wherein each the first connecting member has first thread portion on an outer wall thereof, each the first connecting member has a concave portion thereinside, each the ball seat has second thread portion on an inner wall thereof, the second thread portion of the ball seat is engaged with the first thread portion of the first connecting member, and the ball body is partially received in the concave portion of the first connecting member.

6. The monitor supporting structure according to claim 4, wherein each the ball body has a connecting hole on one side thereof, each the second connecting member has a connecting bolt on the other side thereof, and the connecting bolt of the second connecting member is screwed with the connecting hole of the ball body.

7. The monitor supporting structure according to claim 1, wherein the two second connecting members are long rods.

8. The monitor supporting structure according to claim 1, wherein the through-hole portion is connected to a head-restraint metal-rod of a car seat.

9. The monitor supporting structure according to claim 8, wherein the sleeve of the second connecting member has a threaded hole on a side wall thereof, a fixing screw is screwed with the threaded hole, and the fixing screw selectively abuts against the head-restraint metal-rod of the car seat.

10. The monitor supporting structure according to claims 1, wherein the sleeve of the second connecting member is a turning knob.
